(19) United States
(12) Patent Application Publication
(10) Pub. No.: US 2023/0227333 A1
(43) Pub. Date: Jul. 20, 2023

(54) POTABLE WATER PRODUCING DEVICE

(71) Applicant: Sulis Water International Inc., New Brunswick, NJ (US)

(72) Inventors: Anurag Modak, East Wndsor, NJ (US); Yuki Tong Chul Osumi, Lodi, NJ (US); Sarah Flora Pomeranz, Brookline, MA (US); Arye Shmuel Mendelow, Chicago, IL (US)

(73) Assignee: Sulis Water International Inc., New Brunswick, NJ (US)

(21) Appl. No.: 18/125,145

(22) Filed: Mar. 23, 2023

Related U.S. Application Data
(63) Continuation-in-part of application No. 16/505,456, filed on Jul. 8, 2019, now Pat. No. 11,643,340.
(60) Provisional application No. 62/695,639, filed on Jul. 9, 2018.

(51) Int. Cl. C02F 1/32; C02F 1/72

(52) U.S. Cl. CPC C02F 1/325; C02F 1/725; C02F 2307/10; C02F 2305/023; C02F 2201/3222; C02F 2303/04; C02F 2201/002; C02F 2201/009

(57) ABSTRACT

A water treatment device comprising a clear container with lid surrounded by a solar reflector, and an insert in the form of a thin sheet or mesh permanently coated with titanium dioxide as a water sanitizing catalyst. The container is filled with non-potable water, covered with the lid, and placed in direct sunlight. Direct and reflected sunlight enters the water through the clear container and lid, where the sunlight's UV radiation and increased solar thermal heat disinfect the water. Further, the catalyst on the insert reacts with dissolved oxygen in the water to produce reactive oxygen species. These reactive species react with and decompose organic compounds in the water, and kill or inactivate pathogens. In addition, the reactive oxygen species further react with the water itself to produce additional free radical species, which also react with and decompose organic compounds and kill or inactivate pathogens.

### CROSS-REFERENCE TO RELATED APPLICATIONS SECTION

This application is a U.S. Non-Provisional patent application that is a Continuation-in-Part (CIP) patent application of U.S. Non-Provisional patent application Ser. No. 16/505,456 filed on Jul. 8, 2019, which claims priority from U.S. Provisional Patent Application Ser. 62/695,639 filed on Jul. 9, 2018, the entire contents of which are hereby incorporated by reference in their entirety.

### FIELD OF THE EMBODIMENTS

The invention relates to water sanitation, producing potable water from non-potable water.

### BACKGROUND OF THE EMBODIMENTS

Water purification technologies and methodologies are known, but they are largely inappropriate for use in certain situations. Typically, they require expensive metals and materials, or electricity to help power ultraviolet light lamps in order to function. However, these devices are both expensive to make and require existing infrastructure, such as an electrical grid and a municipal water supply. These may be unavailable in rural areas of countries with underdeveloped economies, or in damaged infrastructure in regions affected by natural disasters. As a result, water-borne diseases are a major threat to affected populations, particularly those in poverty. If water is available but unhealthful to drink, and rendering it potable is too expensive or difficult to achieve, then a sustainable and affordable solution may not be possible. A potable water solution is needed that is both cheap enough for those in poverty to afford, and effective enough to providing potable water to entire communities without the need for infrastructure.

The so-called solar disinfection (SODIS) method may be appropriate for use by individuals in such conditions, but SODIS has limitations that make it ineffective for use on a scale suitable to supply entire communities. SODIS sanitizes water effectively only if it is minimally turbid. Turbidity is a measure of clarity in water that scatters light, such as due to suspended particles. High turbidity substantially reduces light penetration in water and therefore reduces the disinfection efficiency of the SODIS treatment process. To ensure safe water disinfection, raw water should have turbidity less than 30 Nephelometric Turbidity Units (NTUs). In addition, UV-radiation is reduced by increasing water depth. At a water depth of 10 cm and moderate turbidity level of 26 NTU, sanitizing UV-A radiation is reduced by 50%, so a clear container of raw water must be left in continuous sunlight for at least twelve hours for SODIS to be effective. Therefore, containers used for SODIS should be as flat as possible, preferably having a water depth no more than 10 cm. Accordingly, SODIS systems are generally sized for use by individuals, but are not appropriate for use by entire communities.

Chemical treatments are also commonly used to purify water, but these are inappropriate where the chemicals are unavailable, expensive, or toxic if used improperly. For example, flocculation is possible only when flocculant is available. And, some chlorine-based treatments may react with industrial pollutants in groundwater to produce other, carcinogenic chemicals, thereby transforming one dangerous contaminant into another.

Reverse osmosis mitigates some of these shortcomings, but it creates a large amount of wastewater, about 3-4 times the amount of potable water produced. Thus, it is not appropriate in areas where water is scarce. Moreover, the wastewater contains higher concentrations of pollutants than the original water such as dissolved salts, organic matter, and toxic metals. Reverse osmosis systems also demineralize water. Drinking water with a low mineral content can increase diuresis, which in turn increases the elimination of some essential elements in the body. Demineralized water can also be somewhat acidic, and can cause acidosis, which can cause degenerative diseases.

Thus, the systems and methods of the prior art to produce potable drinking water have significant disadvantages for large-scale use.

### SUMMARY OF THE EMBODIMENTS

A water treatment device comprising a clear container with lid surrounded by a solar reflector, and an insert in the form of a thin sheet or mesh permanently coated with titanium dioxide as a catalyst. The container is filled with non-potable water, closed with the lid, and placed in direct sunlight. Direct and reflected solar radiation enters the clear container, where the sunlight's ultraviolet (UV) radiation and increased solar thermal temperature disinfect the water. Further, the catalyst on the insert reacts with dissolved oxygen in the water to produce reactive oxygen species. These reactive species react with and decompose organic compounds in the water, and kill or inactivate pathogens. In addition, the reactive oxygen species further react with the water itself to produce additional free radical species, which also react with and decompose organic compounds and kill or inactivate pathogens.

It is to be understood that both the foregoing general description and the following detailed description and drawings are exemplary and explanatory and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate disclosed embodiments and aspects and, together with the description, serve to explain the principles of the invention, the scope of which is determined by the claims.

In the drawings:

FIGS. 1A and 1B show wireframe side views of an exemplary water sanitizing device embodiment in assembled and expanded views, respectively, in accordance with the disclosure.

FIGS. 2A and 2B show side views of the exemplary water sanitizing device embodiment of FIGS. 1A and 1B, respectively, viewed from the front.

FIGS. 3A and 3B show side views of the exemplary water sanitizing device embodiment of FIGS. 2A and 2B, respectively, viewed from the side.

FIGS. 4A and 4B show perspective views of the exemplary water sanitizing device embodiment of FIGS. 2A and 2B, with the lid on and off of the container respectively.

FIG. 5 shows an expanded side view of the exemplary water sanitizing device embodiment of FIG. 1B with a solar reflector.

FIGS. 6A through 6H show perspective and top views of various exemplary catalytic inserts.

FIGS. 7A through 7C show a container embodiment shown with various catalytic inserts ready to be placed in a solar reflector.

FIGS. 8A and 8B show an exemplary container covered with lid containing mesh and solid catalytic inserts, respectively.

FIGS. 9A and 9B show perspective and top views of an exemplary container with a plurality of nested right circular cylindrical mesh catalytic inserts.

FIGS. 10A and 10B show an embodiment in the shape of a box, and a trap that may be coupled thereto, in accordance with the disclosure.

FIG. 11 depicts an exploded view of a water sanitizing device having a snap-on configuration, in accordance with at least some embodiments disclosed herein.

FIG. 12 depicts a perspective schematic view of a solar panel of the water sanitizing device having the snap-on configuration of FIG. 11, in accordance with at least some embodiments disclosed herein.

FIG. 13 depicts a perspective schematic view of ultraviolet (UV) light-emitting diode (LED) strips affixed to a lid of the water sanitizing device having the snap-on configuration of FIG. 11, in accordance with at least some embodiments disclosed herein.

FIG. 14 depicts a perspective schematic view of a coated catalyst affixed to a base of the water sanitizing device having the snap-on configuration of FIG. 11, in accordance with at least some embodiments disclosed herein.

FIG. 15 depicts a top down schematic view of a lid the water sanitizing device having the snap-on configuration of FIG. 11, in accordance with at least some embodiments disclosed herein.

FIG. 16 depicts an exploded view of a water sanitizing device having a hinge configuration, in accordance with at least some embodiments disclosed herein.

FIG. 17 depicts a perspective schematic view of a solar panel of the water sanitizing device having the hinge configuration of FIG. 16, in accordance with at least some embodiments disclosed herein.

FIG. 18 depicts a perspective schematic view of UV LED strips affixed to a lid of the water sanitizing device having the hinge configuration of FIG. 16, in accordance with at least some embodiments disclosed herein.

FIG. 19 depicts a perspective schematic view of a coated catalyst affixed to a base of the water sanitizing device having the hinge configuration of FIG. 16, in accordance with at least some embodiments disclosed herein.

FIG. 20 depicts a top down schematic view of a lid the water sanitizing device having the hinge configuration of FIG. 16, in accordance with at least some embodiments disclosed herein.

FIG. 21 depicts another top down schematic view of a lid the water sanitizing device having the hinge configuration of FIG. 16, in accordance with at least some embodiments disclosed herein.

FIG. 22 depicts a perspective schematic view of the water sanitizing device having the hinge configuration of FIG. 16, in accordance with at least some embodiments disclosed herein.

### DESCRIPTION OF THE PREFERRED EMBODIMENTS

The figures and descriptions provided herein may have been simplified to illustrate embodiments and aspects that are relevant for a clear understanding of the herein described processes, machines, manufactures, and/or compositions of matter, while eliminating for the purpose of clarity, other aspects that may be found in prior art devices, systems, and methods. Those of ordinary skill in the pertinent art may recognize that other elements may be used, or may be required to implement the devices, systems, and methods described herein. Because such elements and steps are well known in the art, and because they do not facilitate a better understanding of the present disclosure, a discussion of such elements and steps may not be provided herein. However, the present disclosure is deemed to inherently include such elements, variations, and modifications to the described embodiments and aspects that would be known to those of ordinary skill in the pertinent art.

It is noted that the components of the present invention, as generally described and illustrated in the figures herein, may be configured and arranged in a variety of embodiments that are different from those described herein, without departing from the scope of the appended claims. Accordingly, the following detailed descriptions and illustrations of embodiments and aspects are not intended to limit the scope of the invention as claimed, but are merely representative of selected illustrative embodiments. The usage of the phrases “embodiments”, “example embodiments”, “some embodiments”, or other similar language refers to the fact that a particular feature, structure, or characteristic described may be included in at least one embodiment of the present invention, and do not necessarily all refer to the same embodiment or group of embodiments. Thus, the described features, structures, or characteristics may be combined in any suitable manner in one or more embodiments.

A variety of illustrative embodiments will now be described. These are provided as teaching examples and should not be interpreted to limit the scope of the invention. Although specific details and aspects of the embodiments are presented, the embodiments may be modified by changing, supplementing, or eliminating many of these details.

In embodiments, the device comprises a clear polyethylene terephthalate (PET) container with a PET lid, and a titanium dioxide-coated catalytic insert. The PET container may be in the form of a contiguous body wall with a solid base defining an enclosed space, and open top. In a currently preferred embodiment, the container may be in the form of a hollow right circular cylinder with a solid bottom and open top, although other shapes may be used. The PET lid may be in the shape of a similarly shaped but much shorter contiguous body wall with a solid top and an open bottom. In a currently preferred embodiment, the lid may be in the form of a short hollow right circular cylinder with a solid top and an open bottom, although other shapes may be used. The open bottom of the lid fits snugly over the open top of the container. The open bottom of the lid may have an edge that matches the edge of the open top of the container. A photocatalyst insert is placed into the space enclosed by the container. In a currently preferred embodiment, the catalytic insert may comprise at least one thin metal sheet or mesh coated with a layer of titanium dioxide. In embodiments, a solar reflector may be used to reflect sunshine into the container.

In use, the container is filled with unpotable water, the catalytic insert is placed in the container, the container is covered with the lid and is placed in direct sunlight for an amount of time sufficient to sanitize the water to a potable condition. There are many ways to configure the container, lid, and catalytic insert to provide for such use. For example, the insert may be in the form of a free standing structure sized to fit in the container, to be placed into the container. Or, the insert may be permanently attached to an inside surface of the container, such as the bottom, the side wall, or both. Or, the insert may be permanently attached to an inside surface of the lid, such as the top. In a currently preferred embodiment, the top of the lid may include a thin slit configured to match an edge of the insert if made from a thin material such as a sheet or mesh, or a hole configured to match the shape of a solid insert, into which the insert may be slid.

In embodiments, the catalytic insert may be in the form of a solid prism having a base that is a triangle, quadrilateral such as a square or rectangle, or other shape. In other embodiments, the insert may be in the form of a thin sheet or mesh. The sheet or mesh may be flat, or may be configured to present a greater surface area to the water in the container, such as a thin walled spiral, or a plurality of thin fins coupled around a central vertical axis, or the like. In embodiments that do not have a lid with slits into which the insert may slide, concentric thin-walled shapes may be used, such as nested cylinders, nested hollow prisms, or the like.

In embodiments, the container may be placed in the reflected light of a solar reflector. Such a reflector may be in the form of a flat or concave sheet that reflects sunlight through the clear sides of the container. Or, the reflector may be in the form of a hollow frustum, that is, the portion of a three dimensional shape that lies between two parallel planes passing through it. The frustum has an inside surface reflecting light toward a central axis. In a currently preferred embodiment, the frustum may be a truncation of a right cone, or a right pyramid having a triangular, square, or other regular polygonal shape, or a circular paraboloid, with a reflective inside surface. The solar reflector may be made of a solid reflective material, or it may be made as a plastic base with a thin reflective coating on the interior surface.

In its simplest form, the invention is intended for use outdoors where ultraviolet radiation from sunlight can directly sanitize water and also initiate photocatalytic reactions. Embodiments may also include a strainer or other filter fitted to the top of the container through which water is passed to remove mud, leaves, and other large particulates as the water is poured into the container.

In embodiments for indoor use, a small solar panel may be provided to power an LED light to provide an ultraviolet photocatalytic light source. In embodiments, the container may be attached to a water tap to provide a constant flow of water through the container. Such embodiments may comprise a solar panel, battery, direct connection to electrical outlet, and/or other source of electricity to power an internal LED to initiate the photocatalytic reaction.

In general, embodiments are effective to decompose organic compounds and kill or inactivate bacteria and viruses present in the water. Because pathogen particles are killed, they cannot divide and propagate. However, the pathogens may maintain enough of their integrity to be recognized by the immune system and evoke an adaptive immune response. Accordingly, drinking water treated by the disclosed embodiments for a limited duration, or even a single instance of ingestion, may have an immunizing effect that may provide some degree of protection against infectious diseases caused by drinking untreated water. Unfortunately however, the embodiments do not mitigate the presence of harmful inorganic compounds.

The disclosed embodiments sanitize the water in the container using photocatalysis, that is, the acceleration of photoreactions in the presence of a catalyst. The photocatalytic activity generates free radicals (e.g. hydroxyl radicals) that can undergo further reactions, including decomposing organic compounds and inactivating pathogens. In the disclosed embodiments, titanium dioxide (TiO2) is the catalyst, although other catalysts may additionally or alternative be used. Thus, the disclosed embodiments reduce the concentration of organic compounds and the population of bacterial, viral, and other microbial species to achieve predetermined concentrations deemed safe for human consumption.

In embodiments, the photocatalyst is created using a titanium dioxide-based coating sintered onto a metal substrate such as aluminum or steel. Alternatively, directly anodized titanium may be used to generate a photoactive coating.

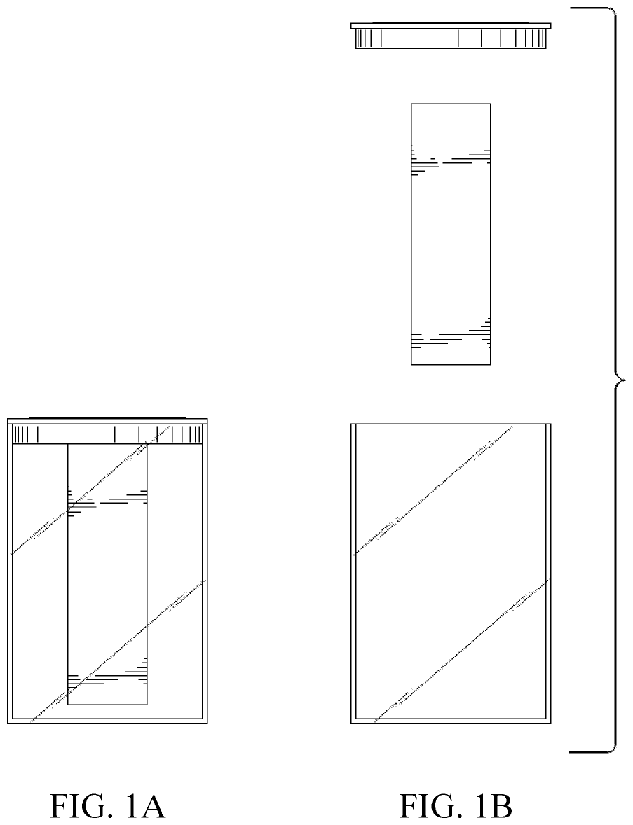

Turning now to the figures, FIGS. 1A and 1B show wireframe side views of an exemplary water sanitizing device embodiment in assembled and expanded views, respectively, in accordance with the disclosure. As shown, the catalytic insert is coupled to the lid and placed into the container filled with unpotable water.

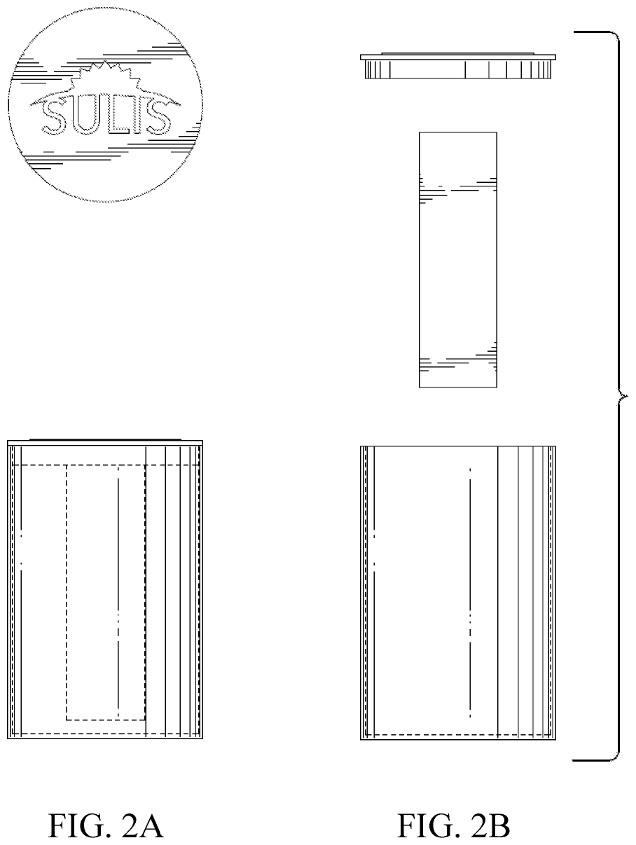

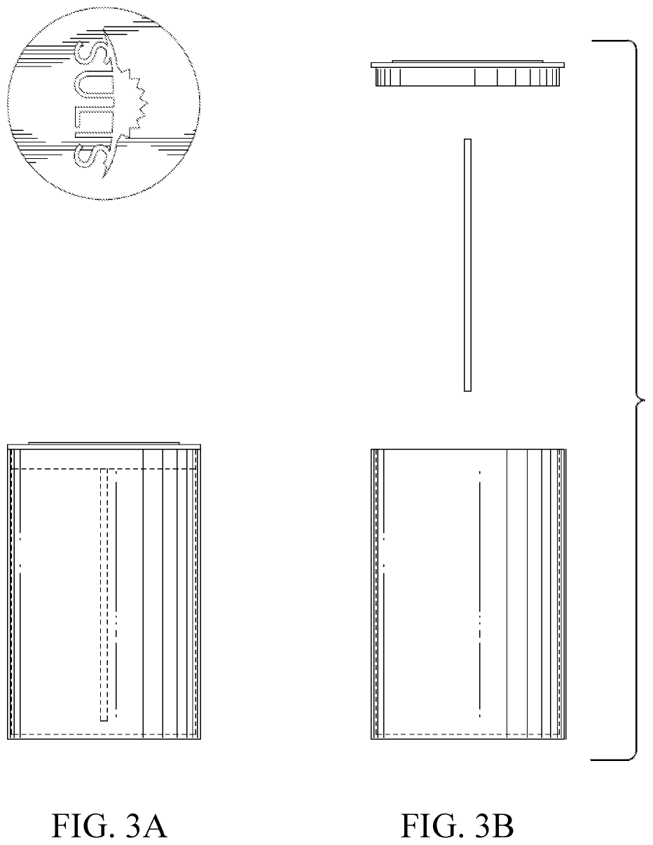

FIGS. 2A and 2B show side views of the exemplary water sanitizing device embodiment of FIGS. 1A and 1B, respectively, viewed from the front, and also showing a top view of the lid. FIGS. 3A and 3B show side views of the exemplary water sanitizing device embodiment shown FIGS. 2A and 2B, respectively, turned 90° clockwise from the position shown in FIGS. 2A and 2B, viewed from the side.

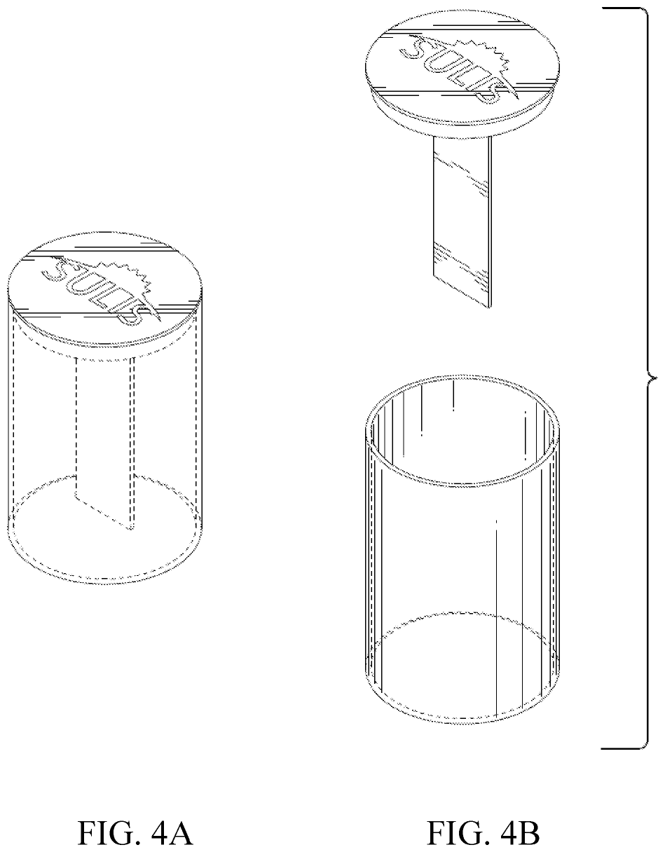

FIGS. 4A and 4B show perspective views of the exemplary water sanitizing device embodiment of FIGS. 2 and 3, with the lid on and off of the container, respectively. As shown in FIG. 4B, the catalytic insert is attached to the lid before the lid is placed on the container.

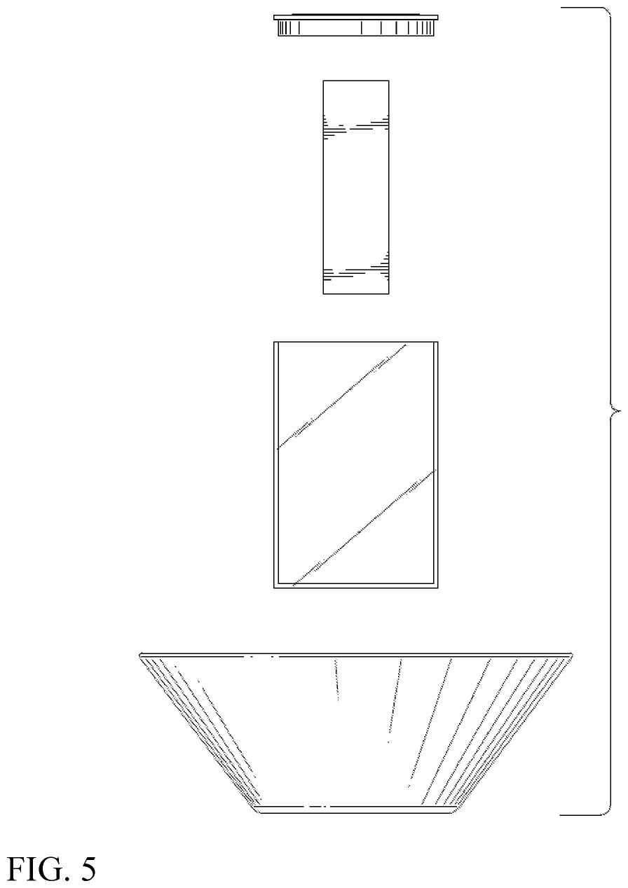

FIG. 5 shows an expanded side view of the exemplary water sanitizing device embodiment of FIG. 1B with the addition of a solar reflector in which the filled and assembled container may be placed.

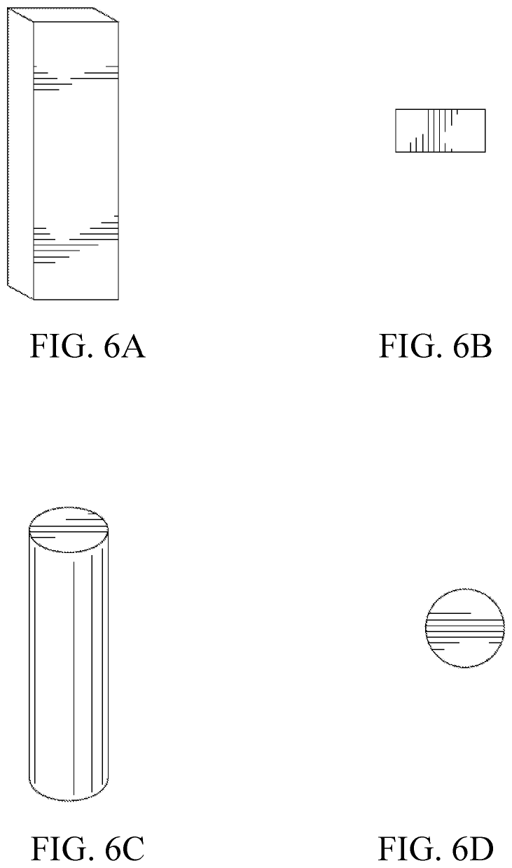

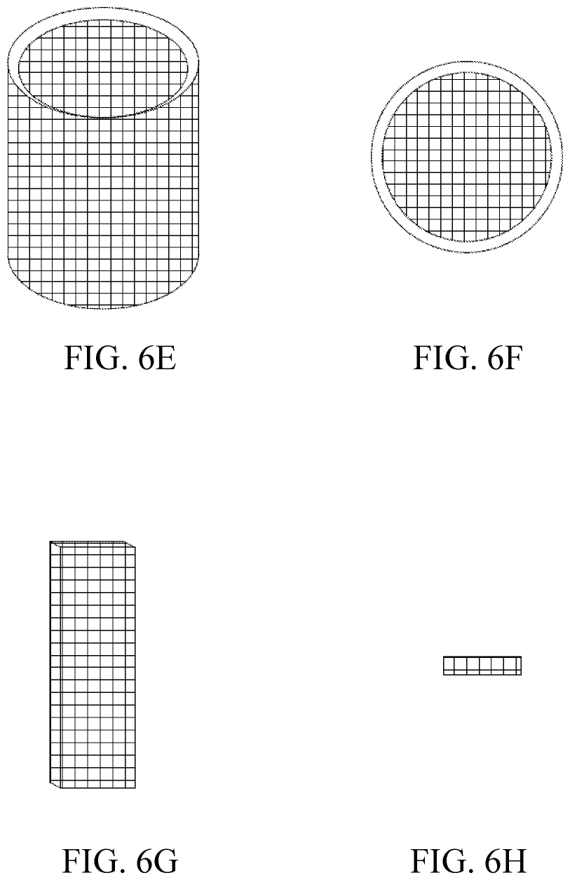

FIGS. 6A through 6H show perspective and top views of various exemplary catalytic inserts, all covered with a layer of TiO2. FIGS. 6A and 6B show perspective and top views, respectively, of a catalytic insert in the form of a solid rectangular prism. FIGS. 6C and 6D show perspective and top views, respectively, of a catalytic insert in the form of a solid circular cylinder. FIGS. 6E and 6F show perspective and top views, respectively, of a catalytic insert in the form of a hollow circular cylinder made of a mesh. And, FIGS. 6G and 6H show perspective and top views, respectively, of a catalytic insert in the form of a hollow rectangular prism made of a mesh.

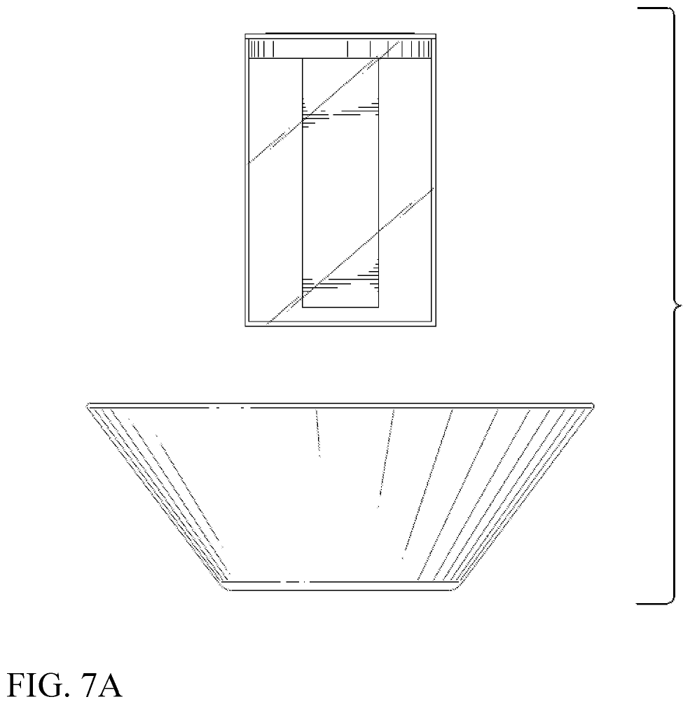

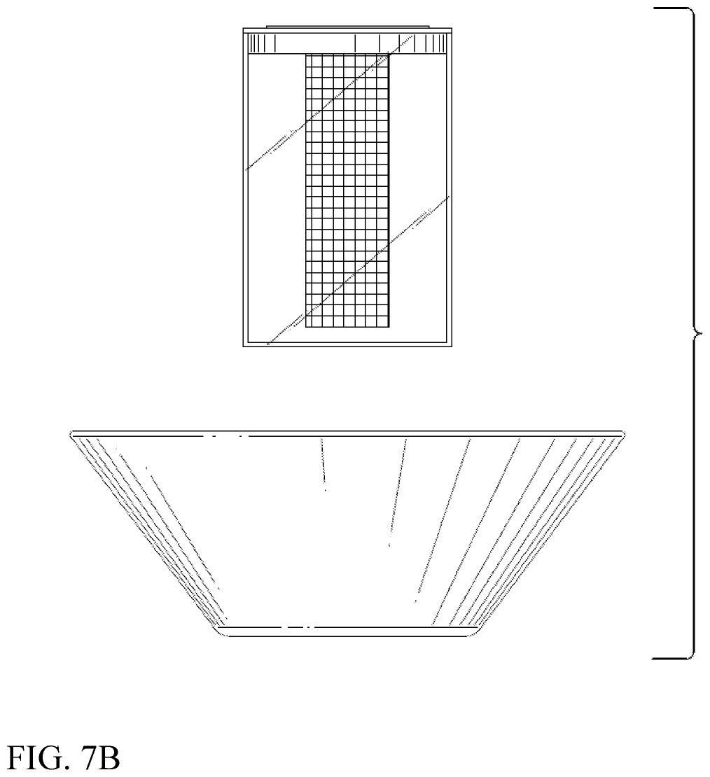

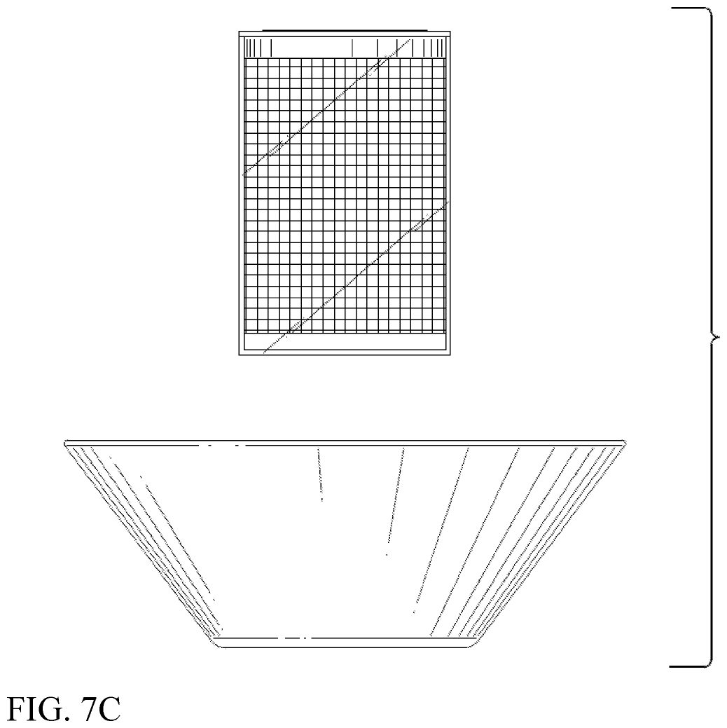

FIGS. 7A through 7C show a container embodiment with lid on enclosing various catalytic inserts ready to be placed in a solar reflector. The catalytic inserts are in the form of a thin solid sheet, a thin mesh of medium width, and a thin mesh fitting snugly inside the container, respectively.

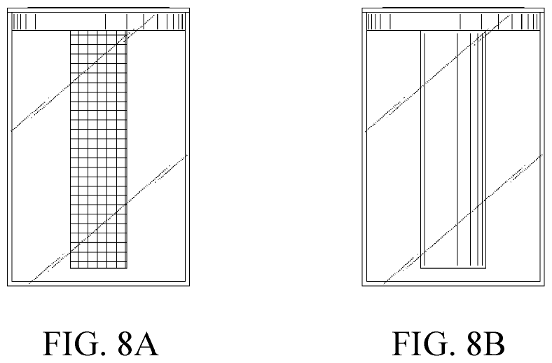

FIGS. 8A and 8B show an exemplary container covered with lid containing mesh and solid catalytic inserts, respectively.

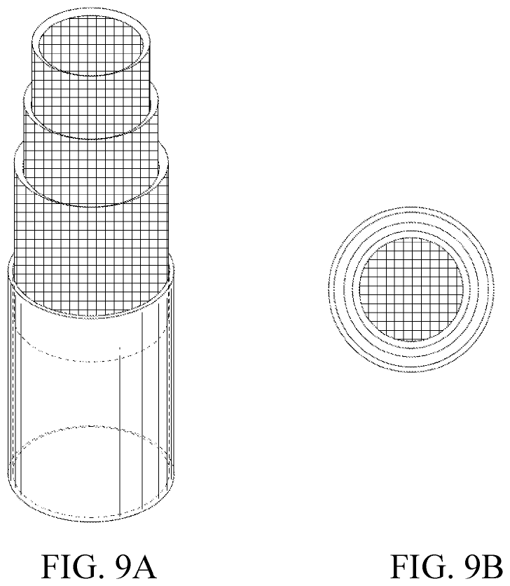

FIGS. 9A and 9B show perspective and top views of an exemplary container with a plurality of nested right circular cylindrical mesh catalytic inserts being assembled.

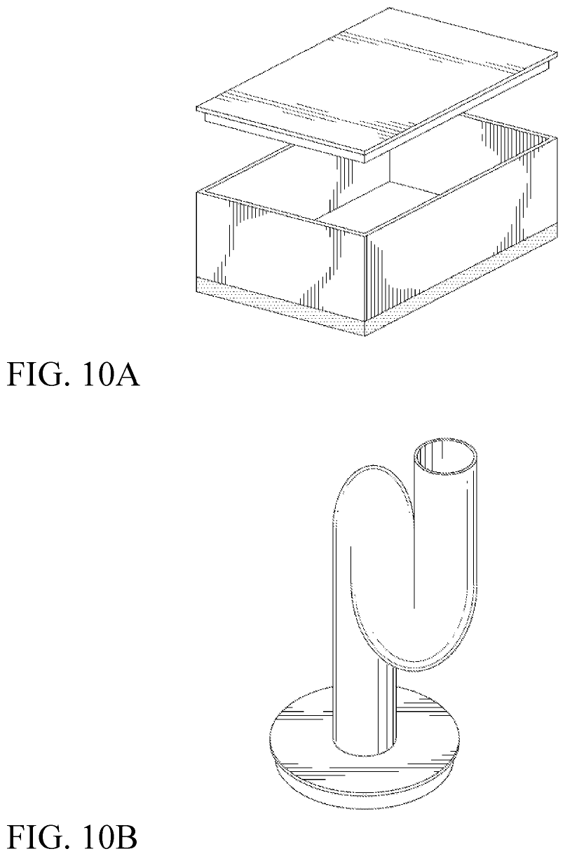

FIGS. 10A and 10B show an embodiment in the shape of a box, and a trap that may be coupled thereto, respectively, in accordance with the disclosure. In this embodiment, the catalytic insert is a flat plate that forms the bottom of the box, covered on the side facing the interior of the box with TiO2. FIG. 10B is a trap that may be attached to the box of FIG. 10A via a hole in the lid (not shown) to catch large particles that may be in the water as the box is filled. The water source may be a tap (not shown) for example, attached to the open end of the trap. This embodiment would be appropriate, for example, for use with a water catchment system that collects rainwater.

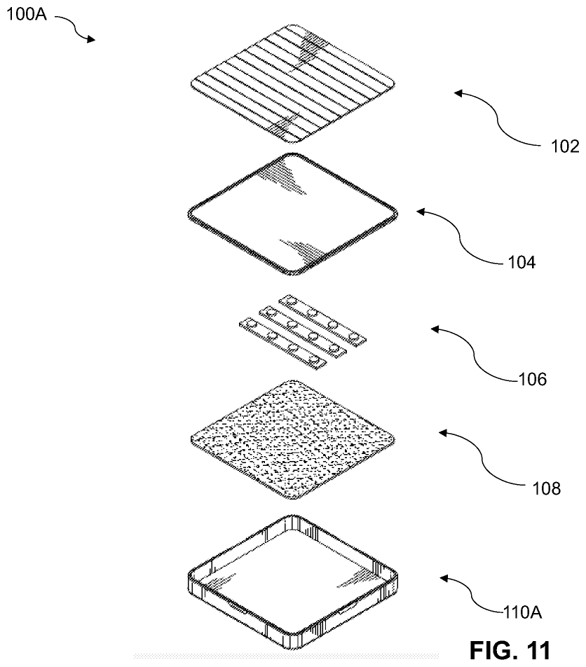

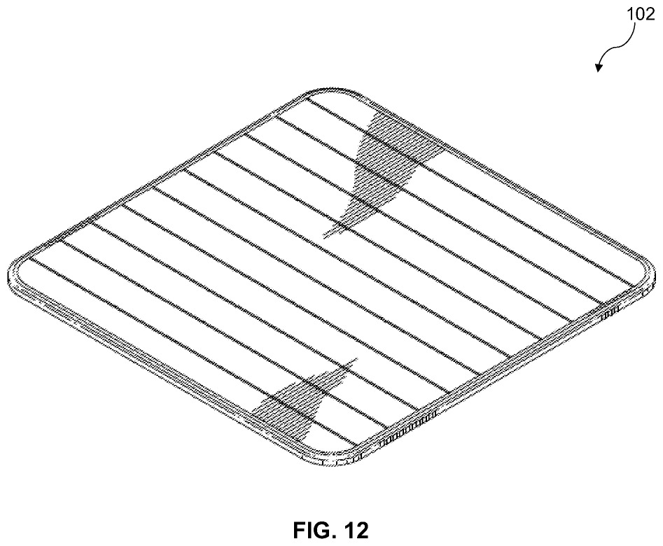

FIG. 11-FIG. 15 depict a water sanitizing device having a snap-on configuration 100A and components of the water sanitizing device. Specifically, FIG. 11 depicts an exploded view of the water sanitizing device having the snap-on configuration 100A, which includes a solar panel 102, a lid 104, one or more UV LED strips 106A, 106B, 106C, a coated catalyst 108, and a base 110A.

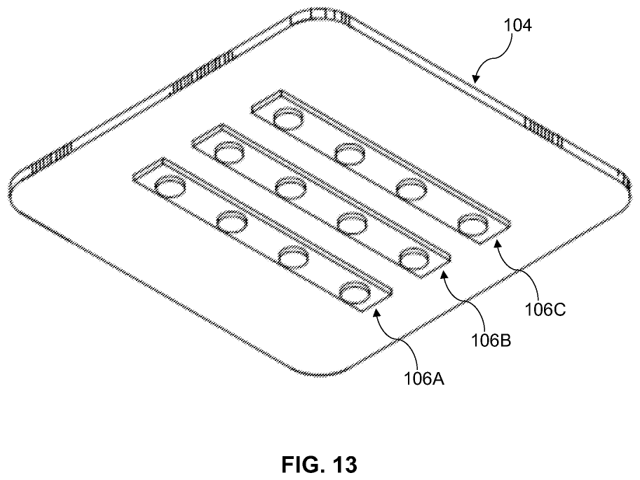

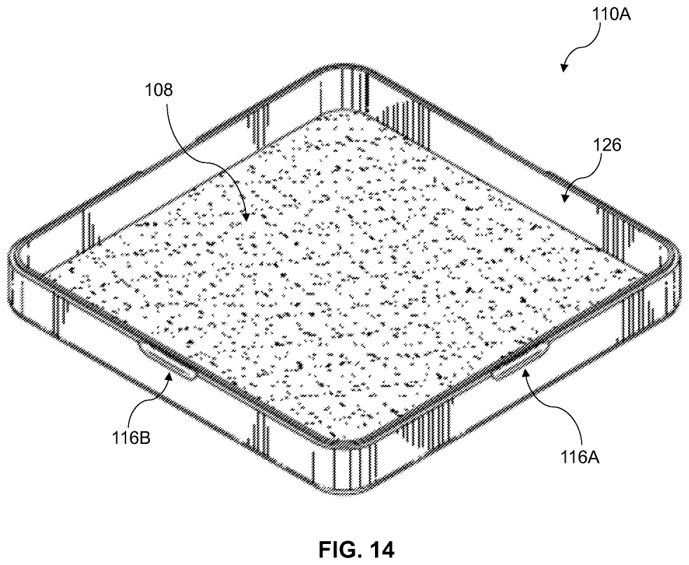

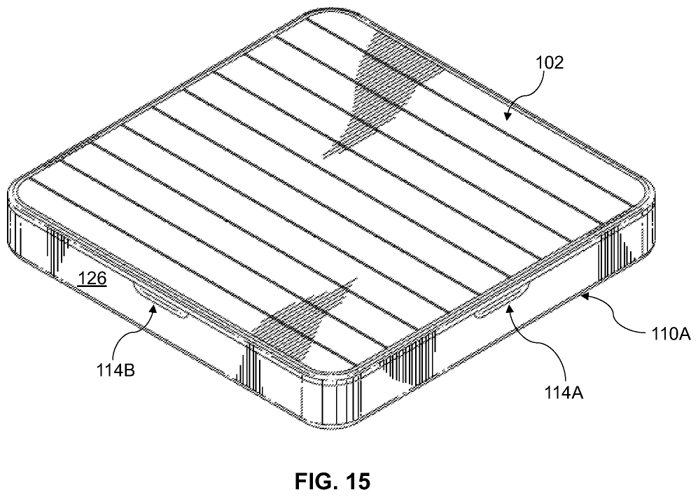

The lid 104 has an external surface disposed opposite an internal surface. The solar panel 102 (of FIG. 11, FIG. 12, and FIG. 15) is directly affixed to an external surface of the lid 104 (of FIG. 11 and FIG. 13) and articulates with the base 110A (of FIG. 11, FIG. 14, and FIG. 15). The lid 104 contains the solar panel 102 affixed to the external surface and the one or more UV LED strips 106A, 106B, 106C (of FIG. 11 and FIG. 13) affixed to the internal surface of the lid 104.

The base 110A has an external surface disposed opposite an internal surface and has a first side disposed opposite a second side and a third side disposed opposite a fourth side. The base 110A is generally square in shape. The base 110 contains an edge 126 disposed circumferentially around the base 110A at the first side, the second side, the third side, and the fourth side and extends away from the internal surface of the base 110A. The coated catalyst 108 (of FIG. 11 and FIG. 14) sits in an internal surface of the base 110A. The base 110A contains the coated catalyst 108 and articulates with the lid 104.

The water sanitizing device having the snap-on configuration 100A comprises snap-on articulations on all four edges to join the lid 104 to the base 110A. Specifically, FIG. 14 depicts recessions 116A, 116B on the edge 126 that create an indentation 114A, 114B (of FIG. 15) when the lid 104 is affixed to the base 110A. A users finger may be received by the indentation 114A, 114B to unsnap the lid 104.

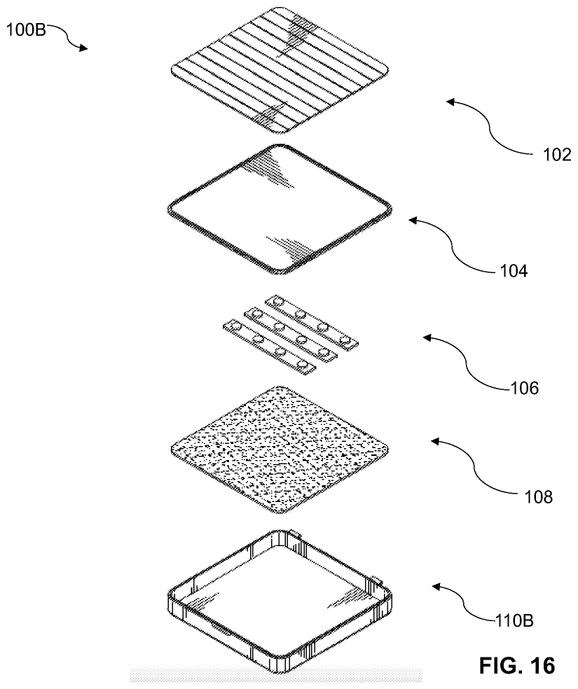

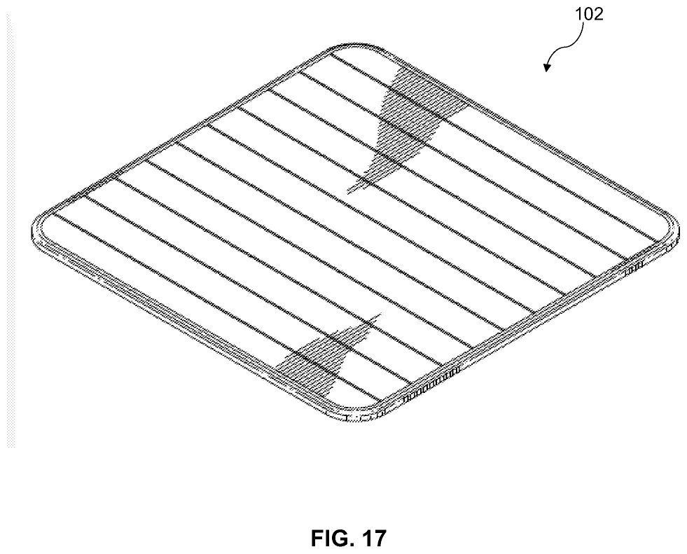

FIG. 16-FIG. 22 depict a water sanitizing device having a hinge configuration 100B. It should be appreciated that the water sanitizing device having the snap-on configuration 100A is substantially similar to the water sanitizing device having the hinge configuration 100B, except these two configurations differ in the means/components to join the lid 104 to the base 110A or 110B. As shown in FIG. 16, the water sanitizing device having the hinge configuration 100B comprises the solar panel 102, the lid 104, the one or more UV LED strips 106A, 106B, 106C, the coated catalyst 108, and the base 110B.

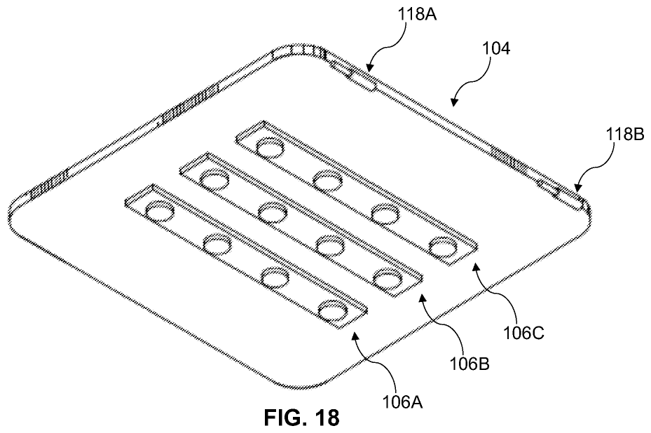

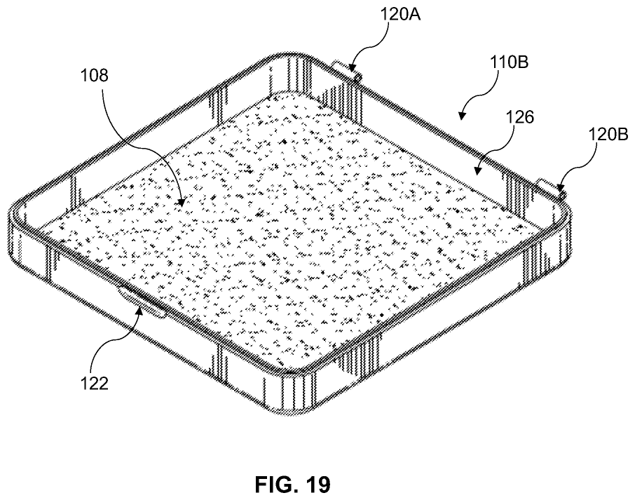

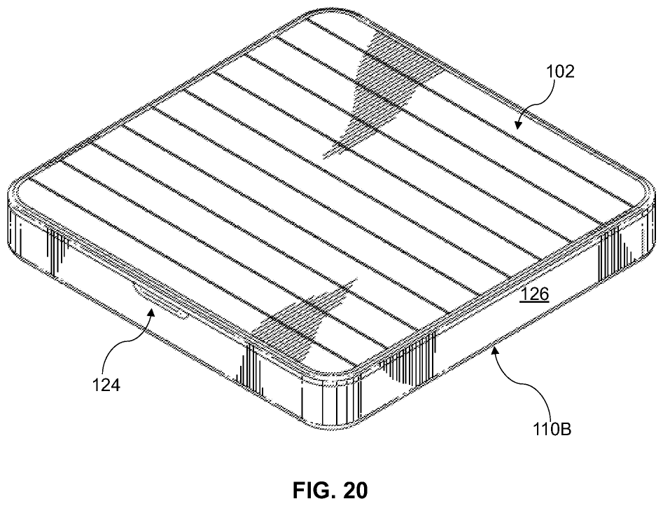

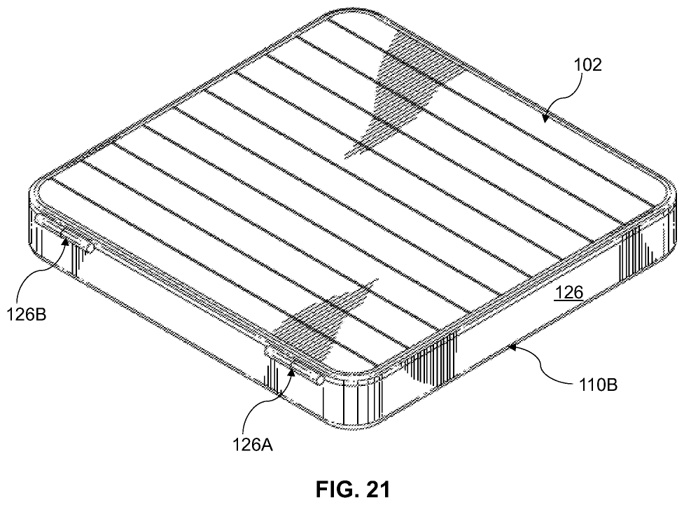

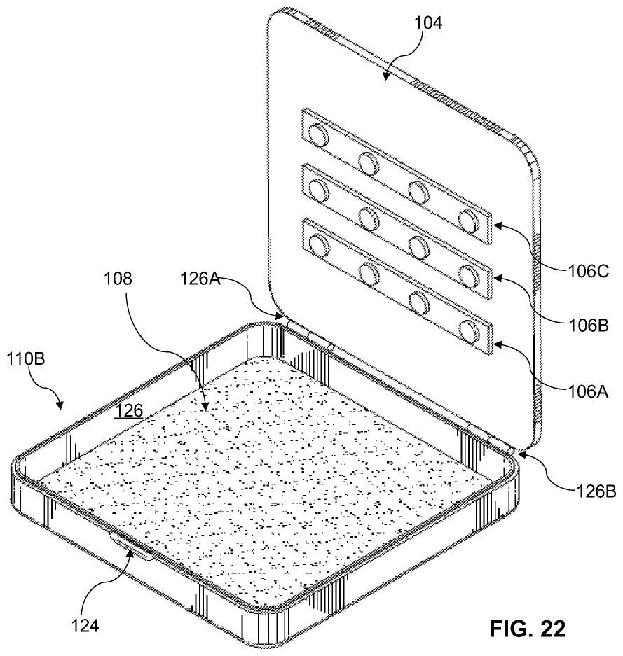

Similar to the configuration of FIG. 11-FIG. 15, the lid 104 of the hinge configuration 100B of the water sanitizing device has an external surface disposed opposite an internal surface. The solar panel 102 (of FIG. 16, FIG. 17, FIG. 20, and FIG. 21) of the hinge configuration 100B of the water sanitizing device is directly affixed to an external surface of the lid 104 (of FIG. 16, FIG. 18, and FIG. 22) and articulates with the base 110B (of FIG. 16, FIG. 19, FIG. 20, FIG. 21, and FIG. 22). The lid 104 contains the solar panel 102 affixed to the external surface and the one or more UV LED strips 106A, 106B, 106C (of FIG. 16, FIG. 18, and FIG. 22) affixed to the internal surface of the lid 104.

The base 110B has an external surface disposed opposite an internal surface and has a first side disposed opposite a second side and a third side disposed opposite a fourth side. The base 110B is generally square in shape. The base 110B contains the edge 126 disposed circumferentially around the base 110B at the first side, the second side, the third side, and the fourth side and extends away from the internal surface of the base 110B. The coated catalyst 108 (of FIG. 16, FIG. 19, and FIG. 22) sits in the internal surface of the base 110B. The base 110B contains the coated catalyst 108 and articulates with the lid 104.

In the hinge configuration 100B of the water sanitizing device of FIG. 16-FIG. 22, hinge articulation joins the lid 104 to the base 110B, with the ability to snap-on the other three edges. For example, FIG. 18 depicts first hinge members 118A, 11B affixed to the internal surface of the lid 104. FIG. 19 depicts second hinge members 120A, 120B affixed to the edge 126 of the base 110B and a first recession 122. FIG. 20 depicts an indentation 124 made by the recession 122 of FIG. 19 when the lid 104 is joined to the base 110B. The users finger may be received by the indentation 124 to unsnap the lid 104.

Further, FIG. 21 and FIG. 22 depicts a first hinge 126A (formed from the first hinge member 118A and the second hinge member 120A) and a second hinge 126B (formed from the second hinge member 118B and the second hinge member 120B). The first hinge 126A and the second hinge 126B are formed between the lid 104 and the base 110B.

It should be appreciated that though three UV LED strips were depicted for the one or more UV LED strips 106A, 106B, 106C in FIG. 11, FIG. 13, FIG. 16, FIG. 18, and FIG. 22, the quantity is not limited to such. The water sanitizing device of FIG. 11-FIG. 22 is generally square (though the shape is not limited to such) and has preferred dimensions of about 1.5 feet×1.5 feet (or about 18 inches×18 inches) with a preferred intended height of about 1.25 inches. With regards to the snap-on configuration 100A of the water sanitizing device of FIG. 11-FIG. 15, of the height, the sides of the base 110A, 110B are about 1 inch high and the sides of the lid 104 are about 0.25 inches high to allow for the snap-on mechanism.

The foregoing embodiments may be enhanced in various ways to accommodate use cases beyond those found in undeveloped rural areas, or in regions with damaged infrastructure caused by natural disasters. Illustratively, these use cases can include the following.

Boats: Many boats have an internal water tank. A photocatalytic water sanitization system embodiment can be used to keep the water in the tank sanitized for long periods of time and help prevent the growth of pathogens in the water.

Aquaponics/hydroponics: A photocatalytic water sanitization system embodiment can help keep pathogens in the circulating water free of microbial species without altering the concentration of inorganic compounds, such as salts, nitrates, phosphates, ammonia, and the like.

Military: A water sanitization system may be reduced in size and adapted into a portable form for use by military personnel.

Agriculture: Water may be sanitized using a photocatalytic system for use in large-scale farming operations. Embodiments of the disclosed photocatalytic water sanitization system may be adapted to process larger volumes of water, for example via mechanization, to generate water with reduced microbial species without altering the inorganic compounds present.

Although the invention has been described and illustrated in exemplary forms with a certain degree of particularity, it is noted that the description and illustrations have been made by way of example only. Numerous changes in the details of construction, combination, and arrangement of parts and steps may be made without deviating from the scope of the invention. Accordingly, such changes are understood to be inherent in the disclosure. The invention is not limited except by the appended claims and the elements explicitly recited therein. The scope of the claims should be construed as broadly as the prior art will permit. It should also be noted that all elements of all of the claims may be combined with each other in any possible combination, even if the combinations have not been expressly claimed.

What is claimed is:

1. A water sanitization device comprising:
a base comprising:
an external surface disposed opposite an internal surface;
a first side disposed opposite a second side;
a third side disposed opposite a fourth side; and
an edge disposed circumferentially around the base at the first side, the second side, the third side, and the fourth side and extending away from the internal surface of the base;
a lid having an external surface disposed opposite an internal surface;
a solar panel directly affixed to the external surface of the lid and configured to articulate with the base;
one or more ultraviolet (UV) light-emitting diode (LED) strips affixed to the internal surface of the lid; and
a coated catalyst affixed to the internal surface of the base, wherein the water sanitizing device comprises water such that when the water sanitizing device is placed in direct sunlight for a sufficient time period, UV radiation and increased solar thermal heat disinfect the water.

2. The water sanitization device of claim 1, wherein the water sanitization device comprises snap-on articulations to join the lid to the base.

3. The water sanitization device of claim 1, wherein the coated catalyst reacts with dissolved oxygen in the water to produce reactive oxygen species.

4. The water sanitization device of claim 3, wherein the reactive oxygen species react with and decompose organic compounds in the water to and kill or inactivate pathogens in the water.

5. The water sanitization device of claim 1, wherein the water sanitization device comprises a hinge configuration that joins the lid to the base.

6. The water sanitization device of claim 1, wherein dimensions of the water sanitization device are about 18 inches×18 inches×1.25 inches.

7. The water sanitization device of claim 1, wherein the water sanitization device is square in shape.

8. The water sanitization device of claim 1, wherein a quantity of the one or more UV LED strips is three.

9. The water sanitization device of claim 1, wherein the coated catalyst comprises a solid impermeable surface.

10. The water sanitization device of claim 9, wherein the solid impermeable surface is in a form of a sheet.

11. The water sanitization device of claim 9, wherein the solid impermeable surface is in a form of nested homologous structures.

12. The water sanitization device of claim 1, wherein the coated catalyst comprises titanium dioxide.
